(19) United States
(12) Patent Application Publication
(10) Pub. No.: US 2015/0252692 A1
(43) Pub. Date: Sep. 10, 2015

(54) System for Recovering Through an Organic Rankine Cycle (ORC) Energy From a Plurality of Heat Sources

(71) Applicants: Juha Honkatukia, Lappeenranta (FI); Antti Pekka Uusitalo, Lappeenranta (FI)

(72) Inventors: Juha Honkatukia, Lappeenranta (FI); Antti Pekka Uusitalo, Lappeenranta (FI)

(73) Assignee: Tri-O-Gen Group B.V., Goor (NL)

(21) Appl. No.: 14/419,385

(22) PCT Filed: Aug. 3, 2012
(86) PCT No.: PCT/NL2012/050548

§ 371 Date: May 20, 2015

(51) Int. Cl. F01K 3/18; F02G 5/02

(52) U.S. Cl. CPC F01K 3/18; F02G 5/02

(57) ABSTRACT

In an ORC energy converter with parallel preheaters and evaporators different waste heat streams of an internal combustion engine are utilized with parallel evaporators in a common ORC energy converter. The ORC energy converter with parallel evaporators has the same working fluid for each evaporator and the working fluid is separated after the pre-feed system or the feed system and the flows are mixed after the evaporators or at the condenser inlet. Also the working fluid sides of the evaporators can be combined so that only the heat source sides are separated.

The invention relates to a system for recovering through an Organic Rankine Cycle (ORC) energy from a plurality of heat sources. The invention also relates to a set of evaporators for use in such a system.

In internal combustion engine power plants, like diesel engine or gas engine power plants, the electricity production can be increased by utilizing the waste heat streams of the engine with steam Rankine cycles or Organic Rankine Cycles (ORC). An ORC process is a Rankine process which uses an organic working fluid instead of a water/steam cycle. In a well planned heat recovery system the increase in electricity production can be as high as 15%, but the practical implementation of such a system is challenging because it involves the utilization of high-temperature waste heat streams, like the waste heat from exhaust gas, as well as the utilization of low-temperature waste heat streams, like the waste heat from charge air and engine cooling water. An energy converter based on Organic Rankine Cycle provides an effective means to utilize low-temperature waste heat in a small scale whereas steam Rankine cycles are normally used in a large scale heat recovery from high-temperature waste heat streams. Utilizing the waste heat streams of different temperature levels often leads to a complicated waste heat recovery system with various working fluids.

It is an aim of the present invention to provide an improvement to the above-mentioned problems. In accordance with the invention this aim is achieved by a system for recovering through an Organic Rankine Cycle (ORC) energy from a plurality of heat sources, comprising a circuit in which an organic working fluid circulates, the circuit including at least one turbine, at least one condenser, at least one pump and at least two evaporators arranged in parallel, each said evaporator being in heat transferring contact with one of said heat sources.

In a preferred embodiment of the ORC energy recovery system according to the invention the circuit further comprises at least two preheaters arranged in parallel and upstream of the respective evaporators, each said preheater being in heat transferring contact with one of said heat sources.

In order to minimize the number of separate parts and connections and provide a system that is both structurally and functionally efficient, each preheater is preferably integrated with a respective evaporator.

To illustrate the effect of the invention, the claimed ORC energy recovery system having parallel evaporators is now compared with separate conventional ORC heat recovery systems for each heat source using a single evaporator in each ORC system. When considering utilizing different waste heat streams of internal combustion engines with multiple ORC processes, the waste heat recovery system would be complicated and really expensive. If waste heat streams are utilized with one ORC process equipped with parallel preheaters and evaporators, the waste heat recovery system can be much simpler and less system components are needed. For example one condenser and one pre-feed system can be used instead of multiple condensers and pre-feed systems. This is estimated to make recovering energy from different waste heat streams of a reciprocating engine using the system of the invention less expensive compared to conventional ORC systems equipped with single evaporators.

In small scale ORC energy converters, secondary losses are larger compared to larger ORC energy converter units. Using the ORC system with parallel preheaters and evaporators will reduce these losses since there is no need for a separate turbine and other components for utilizing each waste heat stream, but only one process including the single turbine can be used for utilizing multiple waste heat streams.

Using parallel preheaters and evaporators in a common ORC system for utilizing different waste heat streams allows the ORC energy converter to be placed in a single comparatively small sized casing which allows the use of the ORC energy converter also in small spaces compared to multiple separate ORC energy converters.

In further preferred embodiments of the ORC energy recovery system according to the invention the parallel evaporators and/or the parallel preheaters may be integrated in a structure connected to the circuit and in heat transferring contact with said plurality of heat sources. By also combining the working fluid sides of the evaporators and/or preheaters so that only the heat source sides of these components are separated, further savings are obtained.

Further preferred embodiments of the ORC energy recovery system according to the invention are defined in the dependent claims.

The invention will be illustrated in the following description and in the appended drawings, in which corresponding elements are identified by reference numerals incremented by “100”, and in which:

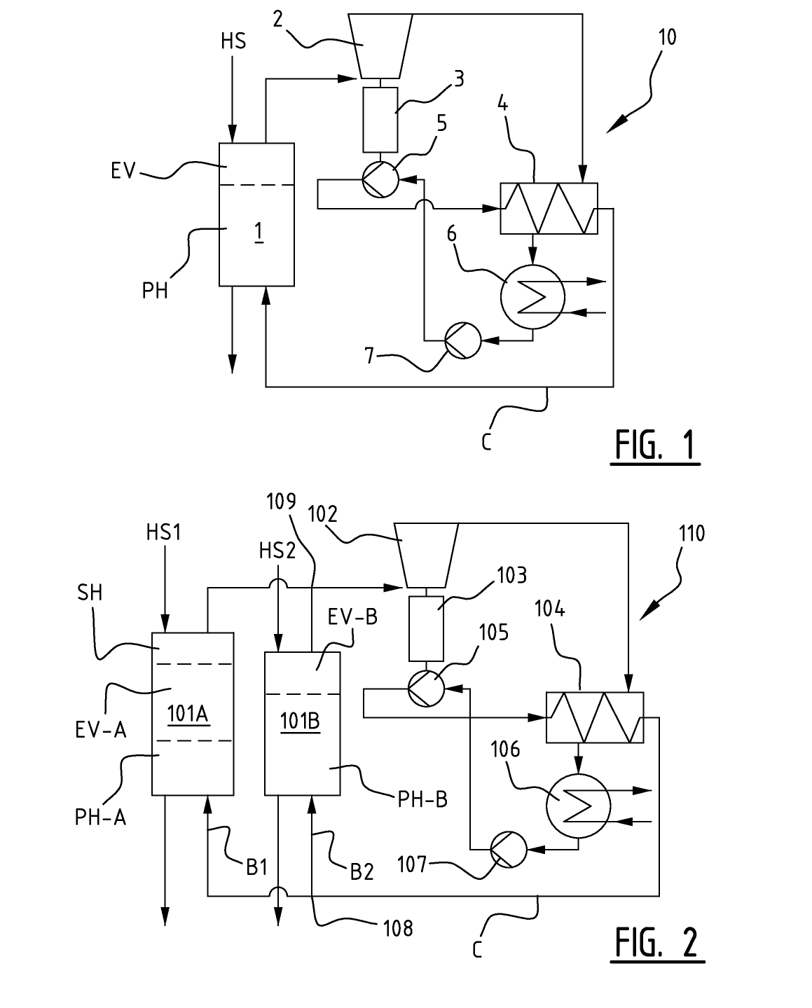

FIG. 1 illustrates the operating principle of a conventional high speed ORC energy converter,

FIG. 2 illustrates a first embodiment of an ORC energy recovery system according to the invention, having parallel evaporators for combining different heat sources to feed one ORC energy converter,

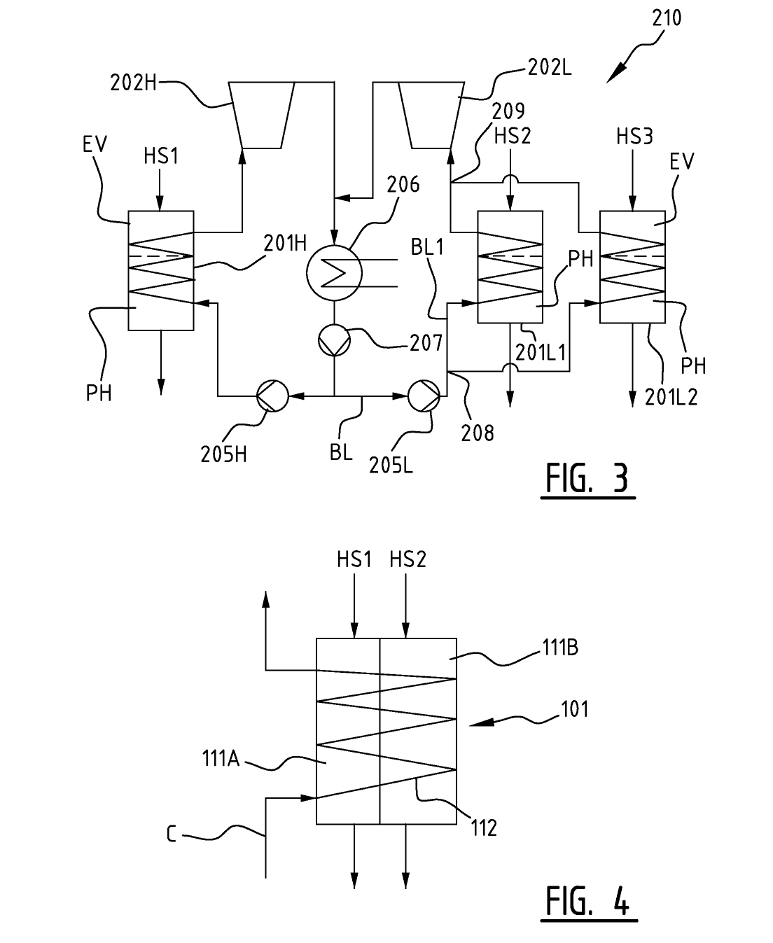

FIG. 3 illustrates a second embodiment of the ORC energy recovery system according to the invention for use with heat sources having substantially different temperatures, and

FIG. 4 illustrates a variant of the parallel evaporators in which the heat source side is separate while the working fluid side is combined.

The main components of a high speed ORC energy converter 10 as illustrated in FIG. 1 are a combined preheater and evaporator 1, a turbine 2, a condenser 6 and a feed pump 5 all connected by a circuit C for circulation of an organic working fluid. Also a recuperator 4 and a pre-feed pump 7 can be used in the ORC energy converter. The liquid organic working fluid is pressurized by the feed pump 5 to a high pressure and then enters the combined preheater and evaporator 1. The working fluid is preheated in the preheater part PH and then evaporated in the evaporator part EV by a heat source HS with which the working fluid is brought into heat transferring contact. Then the vaporized working fluid enters the turbine 2 and expands, causing the turbine 2 to rotate. Rotation of the turbine 2 is converted into electric power by a generator 3. The working fluid exiting the turbine 2 is commonly dry vapor at high temperature and the working fluid heat can be utilized in the recuperator 4 for an initial preheating of the liquid working fluid before it enters the combined preheater and evaporator 1. Low temperature vapor is then condensed in the condenser 6 and pressurized again in one or two steps. In the case of two steps, as illustrated in this embodiment, this is realized by the pre-feed pump 7 and the feed pump 5—which may be driven by the turbine 2. The pre-feed pump might be necessary to provide the feed pump with sufficient initial pressure, and/or to provide pressure for lubrication of the bearings.

The principle of the ORC energy recovery system 110 according to the invention, with its parallel evaporators is shown in FIG. 2. The basic elements are the parallel evaporators EV-A, EV-B in a common ORC energy converter which utilize separate waste heat streams HS1, HS2 (e.g. exhaust gas heat after the primary heat recovery and charge air intercooling heat, both from an internal combustion engine). In the illustrated embodiment each of the evaporators EV-A, EV-B is combined with a respective preheater PH-A, PH-B into an integrated preheater/evaporator 101A, 101B. The ORC energy converter 110 uses a common working fluid for each preheater/evaporator 101A, 101B and the circuit C for the working fluid flow is separated into branches B1, B2 at a location 108 upstream of the parallel preheaters/evaporators after a common pre-feed or feed cycle. Also a common condenser 106 is used for the whole working fluid flow. If the working fluid pressure levels and temperature levels are the same in every preheater/evaporator 101A, 101B, a common feed pump 105 and common turbine 102 can be used in the cycle. In that case the branches B1 and B2 come together at location 109 upstream of the turbine 102. Finally, this embodiment further includes a recuperator 104 between the turbine 102 and the condenser 106.

In the illustrated embodiment a superheater SH is arranged between the first preheater/evaporator 101A and the turbine 102. This superheater SH, which uses the exhaust gas heat, can be integrated with the preheater/evaporator 101A. It serves to superheat the working fluid vapour exiting the evaporator part EV-A of the first preheater/evaporator 101A to such an extent that the mixture of working fluid vapours entering the turbine 102 from the two parallel preheaters/evaporators 101A, 101B has a sufficient amount of heat to prevent condensation in the turbine 102.

Although in the shown embodiment the evaporators EV-A, EV-B are completely separate, in some cases the working fluid sides of the parallel evaporators can be combined. In such an embodiment, which is shown in FIG. 4, only the heat source sides of the evaporators EV-A, EV-B need to be separated. The same idea could be applied to the parallel preheaters PH-A, PH-B as well. This can be achieved if the waste heat streams are guided through chambers 111A, 111B, and if the preheaters/evaporators 101A, 101B include a common conduit or tube 112 for the organic working fluid WF running through these chambers 111A, 111B. Such an embodiment can be simpler from a structural point of view.

An alternative embodiment of the ORC energy recovery system 210 according to the invention is shown in FIG. 3. This system 210 is especially suitable for use when the various heat sources HS1, HS2, HS3 have substantially different temperatures. In this case the heat source HS1 can be exhaust gas heat from an internal combustion engine, which has a relatively high temperature, while the heat sources HS2 and HS3 can be heat from an intercooler and heat from an engine coolant circuit, respectively, which have a much lower temperature. The circuit C in this embodiment has a high temperature/high pressure branch BH and a low temperature/low pressure branch BL. Only the condenser 206 and the pre-feed pump 207 are common to both branches BH, BL. The high temperature/high pressure branch BH includes a dedicated high pressure cycle feed pump 205H, a high temperature evaporator 201H, which is combined with a preheater, and a high pressure cycle turbine 202H. In similar fashion, the low temperature/low pressure branch BL includes a low pressure cycle feed pump 205L and a low pressure cycle turbine 202L. Between the feed pump 205L and the turbine 202L the low temperature/low pressure branch BL is separated at 208 into two branches BL1, BL2 leading to two parallel low temperature evaporators 201L1, 201L2, each of which is again combined with a preheater. These branches BL1, BL2 come together at 209 to lead a common vapour flow to the low pressure turbine 202L.

Although the invention has been illustrated by reference to two embodiments thereof, it will be clear that it is not limited thereto. Many variations and adaptations of the inventive concept may be envisaged. The scope of the invention is defined solely by the appended claims.

1. A system for recovering through an Organic Rankine Cycle (ORC) energy from a plurality of heat sources, said system comprising a circuit in which an organic working fluid circulates, the circuit including at least one turbine, at least one condenser, at least one pump and at least two evaporators arranged in parallel, each said evaporator being in heat transferring contact with one of said heat sources.

2. The ORC energy recovery system according to claim 1, wherein the circuit further comprises at least two preheaters arranged in parallel and upstream of the respective evaporators, each said preheater being in heat transferring contact with one of said heat sources.

3. The ORC energy recovery system according to claim 2, wherein each preheater is integrated with a respective evaporator.

4. The ORC energy recovery system according to claim 2, wherein each preheater has an inlet that is connected to a liquid feed line of the circuit originating at the at least one pump, and wherein each evaporator has an outlet that is connected to a vapour line leading to the at least one turbine.

5. The ORC energy recovery system according to claim 4, further comprising a superheater arranged between the outlet of at least one of the evaporators and the turbine.

6. The ORC energy recovery system according to claim 5, wherein the superheater is integrated with the respective evaporator.

7. The ORC energy recovery system according to claim 1, wherein the parallel evaporators are integrated in a structure connected to the circuit and in heat transferring contact with said plurality of heat sources.

8. The ORC energy recovery system according to claim 1, wherein the parallel preheaters are integrated in a structure connected to the circuit and in heat transferring contact with said plurality of heat sources.

9. The ORC energy recovery system according claim 1, wherein the at least one pump comprises a pre-feed pump and a feed pump arranged in series in the circuit.

10. The ORC energy recovery system according to claim 1, wherein a recuperator is arranged in the circuit between the at least one turbine and the at least one condenser, and wherein a part of the circuit between the at least one pump and the evaporators is arranged in the recuperator.

11. The ORC energy recovery system according claim 1, wherein at least two of the heat sources have substantially different temperatures and wherein the circuit has at least two branches, each branch including at least one evaporator and a turbine matched to the temperature of the heat source.

12. The ORC energy recovery system according to claim 11, wherein one of the heat sources is connected to an engine exhaust and the turbine in the corresponding branch is a high-pressure turbine, and wherein at least one of the other heat sources is connected to an engine coolant circuit or a charge air intercooler and the turbine in the corresponding branch is a low-pressure turbine.

13. The ORC energy recovery system according to claim 11, wherein at least one of the branches includes at least two parallel evaporators in heat transferring contact with different heat sources.

14. A set of at least two parallel evaporators arranged to be brought into heat transferring contact with different ones of a plurality of heat sources for use in an ORC energy recovery system according to claim 1.

15. The evaporator set according to claim 14, further comprising at least two preheaters arranged in parallel and upstream of the respective evaporators, each said preheater arranged to be brought into heat transferring contact with one of said heat sources.

16. The ORC energy recovery system according to claim 12, wherein at least one of the branches includes at least two parallel evaporators in heat transferring contact with different heat sources.

17. The ORC energy recovery system according to claim 3, wherein each preheater has an inlet that is connected to a liquid feed line of the circuit originating at the at least one pump, and wherein each evaporator has an outlet that is connected to a vapour line leading to the at least one turbine.

18. The ORC energy recovery system according to claim 17, further comprising a superheater arranged between the outlet of at least one of the evaporators and the turbine.

19. The ORC energy recovery system according to claim 18, wherein the superheater is integrated with the respective evaporator.
